(19) United States
(12) Patent Application Publication
(10) Pub. No.: US 2010/0142683 A1
(43) Pub. Date: Jun. 10, 2010

(54) Method and apparatus for providing video relay service assisted calls with reduced bandwidth

(76) Inventors: Stuart Owen Goldman, Scottsdale, AZ (US); Mark A. Walter, Aurora, IL (US)

Correspondence Address: Alcatel-Lucent USA Inc.,;Docket Administrator - Room 2F-192, 600 Mountain Avenue, Murray Hill, NJ, 07974-0636, US

(21) Appl. No.: 12/316,070

(22) Filed: Dec. 9, 2008

(51) Int. Cl. H04M 11/00; H04N 7/14

(52) U.S. Cl. 379/52; 348/14.01; 348/E07.077

(57) ABSTRACT

The bandwidth use for Video Relay Service (VRS) assisted calls for hearing impaired individuals is reduced by transmitting a sequence of corresponding sign identification (ID) numbers rather than a video of the signing itself. The signs may be captured by a video camera and recognized by a previously trained sign recognition algorithm, which advantageously converts the signs to sign ID numbers for transmission. Then, at the receiving end, the sequence of ID numbers may be advantageously re-converted back into signs, which may, for example, be displayed on a video screen with use of an artificially created (e.g., a “cartoon”) image comprising (at least) a pair of hands.

### FIELD OF THE INVENTION

The present invention relates generally to the field of Video Relay Service (VRS) assisted calls for hearing impaired individuals, and more particularly to a method and apparatus for reducing the communications network bandwidth that is used to effectuate such calls.

### BACKGROUND OF THE INVENTION

Video Relay Service (VRS) is a telecommunications service that allows deaf and other hearing impaired individuals to communicate over the telephone line with hearing people in real-time, by using a sign language interpreter. An individual who communicates with, for example, American Sign Language (ASL), uses a videophone or other video device, such as a webcam, to connect to a Video Relay Service. This connection is typically provided via broadband Internet.

In the operation of VRS, the hearing impaired caller is routed to a sign language interpreter, known as the “operator” (or the video interpreter), who is also located in front of a videophone or other video device (e.g., a webcam). The hearing impaired video user gives the operator a voice number to dial (using sign language), as well as any special dialing instructions. The operator then places the call and provides interpretation as a neutral, non-participating third party. Anything that the audio user says is signed by the operator to the hearing impaired video user, and anything signed by the hearing impaired video user is spoken by the operator to the audio user.

Similarly, hearing people can call a deaf, hard-of-hearing, or speech-disabled person via VRS. To initiate a call, the hearing person calls the VRS, and is connected to an operator who then contacts the hearing impaired video user. The call then proceeds as described above, wherein anything that the audio user says is signed by the operator to the hearing impaired video user, and anything signed by the hearing impaired video user is spoken by the operator to the audio user.

Note that some hearing impaired people who know sign language prefer to use their own voice when talking to people on the call, and also prefer to hear the other person on the call. If the hearing impaired user doesn't hear them completely (e.g., because of an accent, degradation of the voice line, background noise, or topics with which the hearing impaired user is unfamiliar), then the video relay operator (the video interpreter) can relay those portions of the call that the user misses. Video relay service is also useful in a variety of other situations such as the checking of voice messages. It also supports communication with other people who use sign language. There are a number of video equipment and service providers who provide Video Relay Service.

However, a problem occurs when there is limited or insufficient bandwidth available for use by a Video Relay Service, since current video transmission techniques rely on high bandwidth availability and minimal loss of transmitted data. In particular, a missing piece of the video transmission for even a few seconds during a Video Relay Service call can make a conversation unintelligible, since a number of gestures can be captured within that time.

Specifically, in such cases, the resultant “dropouts” often cause signing by an operator to be unintelligible to the hearing impaired user, and vice versa. Since the Internet typically provides the communication network for VRS, it subjects the high bandwidth requirements of the service to losses and delays when the needed bandwidth is unavailable or unreliable. Moreover, not everybody has access to a well managed, high speed (i.e., broadband) Internet connection. Some people may be limited to less than perfect high speed connections, such as, for example, DSL connections at the distance limit of DSL, poor wiring (resulting in hits requiring retransmission and therefore resulting in lower bandwidth), shared WiFi connections with reduced bandwidth (resulting from the simultaneous demands from multiple users), and dial up (non-broadband) connections. That is, even if the network being used for the VRS itself may have sufficient bandwidth, the user's access connection to that network may be severely limited and thus the service may not always provide its advertised capability.

### SUMMARY OF THE INVENTION

We have recognized that the bandwidth use for VRS calls can be dramatically reduced. Specifically, we have recognized that, since VRS comprises a video transmission of a person signing, and since there are only a finite number of possible signs, the bandwidth used by a novel VRS system in accordance with the principles of the present invention may be advantageously reduced by transmitting a sequence of numerical indicia—for example, sign identification (ID) numbers—rather than a video of the signing itself. Then, at the receiving end, in accordance with one illustrative embodiment of the present invention, the received sequence of ID numbers may be advantageously re-converted back into signs, which may, for example, be displayed on a video screen with use of an artificially created (e.g., a “cartoon”) image comprising (at least) a pair of hands.

In particular, in accordance with one illustrative embodiment of the present invention, a video scanner connected to a PC watches the operator sign; each sign as captured by the video scanner is recognized (by software running on the PC) and mapped to a table of possible signs, selecting a corresponding ID number thereof (i.e., an ID number which has been associated with the given sign); and the resultant sequence of ID numbers is transmitted across the Internet to the hearing impaired user. Then, in accordance with one illustrative embodiment of the present invention, the user's PC runs a display program which causes a pair of “cartoon” hands (or other artificially created image having a pair of hands) to mimic the sequence of signs (which correspond to the sequence of received sign ID numbers) on the screen.

Similarly, in accordance with one illustrative embodiment of the present invention, a video scanner connected to a PC watches the hearing impaired user sign; each sign as captured by the video scanner is recognized (by software running on the PC) and mapped to a table of possible signs, selecting a corresponding ID number thereof (i.e., an ID number which has been associated with the given sign); and the resultant sequence of ID numbers is transmitted across the Internet to the operator. Then, in accordance with one illustrative embodiment of the present invention, the operator's PC runs a display program which causes a pair of “cartoon” hands (or other artificially created image having a pair of hands) to mimic the sequence of signs (which correspond to the sequence of received sign ID numbers) on the screen.

More specifically, in accordance with one illustrative embodiment of the present invention, a method and apparatus provides a telecommunications service for use by a hearing impaired individual, the method or apparatus comprising capturing a sequence of signs produced by a signing person in accordance with a predetermined sign language; identifying each of said signs in said sequence of signs produced by the signing person as corresponding to a particular sign in said predetermined sign language, thereby generating a sequence of identified signs in said predetermined sign language; determining a sequence of numerical indicia representative of said sequence of identified signs in said predetermined sign language, each of said numerical indicia corresponding to one or more of said signs in said sequence of identified signs; and transmitting the sequence of numerical indicia across a communications network for use in said telecommunications service.

In addition, in accordance with another illustrative embodiment of the present invention, a method and apparatus provides a telecommunications service for use by a hearing impaired individual, the method or apparatus comprising receiving a sequence of numerical indicia from a communications network, the sequence of numerical indicia being representative of a sequence of signs in a predetermined sign language; selecting, for each of said received numerical indicia in said sequence, one or more corresponding images and/or video segments for display, wherein each of said images and/or video segments comprises an illustration which comprises at least a pair of hands, and wherein each of said images and/or video segments shows a particular one of said signs in said predetermined sign language being produced by said pair of hands, said particular one of said signs in said predetermined sign language corresponding to said received numerical indicia representative thereof; and displaying each of said selected images and/or video segments in sequence, thereby generating a display of a sequence of images and/or video signals corresponding to the received sequence of numerical indicia.

### BRIEF DESCRIPTION OF THE DRAWINGS

FIG. 1 shows a Video Relay Service call being performed between a hearing impaired user and an audio user in accordance with one illustrative embodiment of the present invention.

FIG. 2 shows a flowchart of a method for capturing and transmitting signs for use in performing a Video Relay Service call between a hearing impaired user and an audio user in accordance with one illustrative embodiment of the present invention.

FIG. 3 shows a flowchart of a method for receiving and displaying signs for use in performing a Video Relay Service call between a hearing impaired user and an audio user in accordance with one illustrative embodiment of the present invention.

### DETAILED DESCRIPTION OF THE PREFERRED EMBODIMENTS

In accordance with one illustrative embodiment of the present invention, a video scanner (e.g., a video camera) is used by both an operator and a hearing impaired user during a Video Relay Service call. The video scanner advantageously captures signs as they are given (by either the operator or the hearing impaired user), and the system (e.g., a Personal Computer to which the corresponding video scanner is connected) then recognizes each sign as a particular one of a number of previously defined signs, selected from a previously stored table of possible signs. Each sign in the table of possible signs advantageously has associated therewith a corresponding sign ID number, and the resultant sequence of sign ID numbers (representative of the sequence of recognized signs) is transmitted (e.g., across the Internet) to the hearing impaired user or to the operator, respectively. Then, in accordance with one illustrative embodiment of the present invention, the system (e.g., a Personal Computer) which receives the aforementioned sequence of sign ID numbers advantageously runs a display program which causes a pair of “cartoon” hands.(or another artificially created illustration, which may comprise still images and/or video segments, having at least a pair of hands) to mimic the corresponding sequence of received signs on the display screen (i.e., a computer monitor).

In accordance with various illustrative embodiments of the present invention, therefore, bandwidth use for VRS calls is dramatically reduced as a result of sending only a sequence of sign ID numbers through the (potentially) limited bandwidth portions of the communications channel. In particular, the transmission of a series of sign ID numbers obviously requires much less bandwidth than the alternative of transmitting a video signal or a sequence of image signals.

Moreover, there is an added benefit advantageously achieved by the various illustrative embodiments of the present invention, in that, since the “cartoon” hands (or other artificially created image or video having at least a pair of hands) which are signing on the display is computer generated, these signs will be uniform each time a given sign ID number is to be displayed. Therefore, the user will advantageously become accustomed to this uniformity and will not need to deal with the normal human variation of signing depending on who is generating the signs.

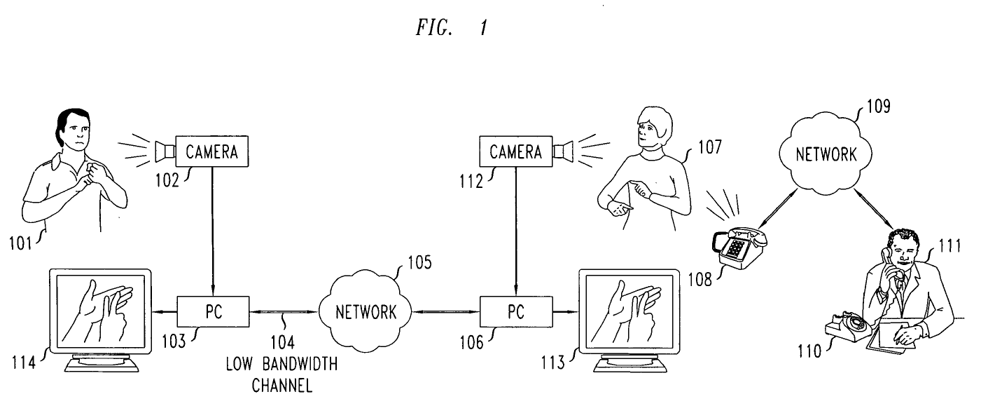

FIG. 1 shows a Video Relay Service call being performed between a hearing impaired user and an audio user in accordance with the above-described illustrative embodiment of the present invention. The figure shows a communication (i.e., a “conversation”) being held by hearing impaired individual 101, who uses sign language to communicate, with audio (i.e., hearing and speaking) user 111, who communicates via a spoken voice. Note that the conversation shown in FIG. 1 could have been initiated by either party.

Communication in one direction (i.e., left to right, as shown in the Figure), is initiated by the signing performed by hearing impaired individual 101. This sign language is advantageously captured using scanner (i.e., video camera) 102, which is connected (as an input device) to Personal Computer (PC) 103 (i.e., hearing impaired individual 101's PC). PC 103 then executes a program which performs sign language recognition on the received signs. This sign language recognition procedure may be advantageously based on the results of a previously executed training (i.e., learning) algorithm, whereby the signs in the given language (e.g., ASL) have been previously “learned” by the system (see the detailed discussion below). PC 103 then advantageously converts the recognized signs to sign ID numbers which are then (easily) sent across low bandwidth channel 104, through network 105 (which may, for example, comprise the Internet), and to PC 106, which is used by operator (i.e., video interpreter) 107.

Upon receipt of this sequence of sign ID numbers by PC 106, a signing display program is executed on the PC. Specifically, the sequence of received sign ID numbers is converted to a corresponding sequence of signs, which are advantageously displayed on PC monitor 113 as a sequence of images comprising a pair of “cartoon” hands (or other artificially created images or video segments having, at least, a pair of hands) which is drawn on the screen so as to display the corresponding sequence of received signs. Operator 107 views the displayed sequence of signs, translates the displayed sign language into a spoken language (e.g., English), and then speaks the resultant translation into conventional telephone 108. Telephone 108 transmits the spoken audio through Public Switched Telephone Network (PSTN) 109 to conventional telephone 110, which allows audio (i.e., hearing and speaking) user 111 to hear the resultant translation (as spoken by operator 107).

Similarly, communication in the other direction (i.e., right to left, as shown in the Figure), is effectuated by audio user 111 speaking (by voice) into telephone 110. Audio user 111's voice is thereby transmitted through PSTN 109 to telephone 108, which is being used by operator 107. Operator 107 translates the spoken voice into sign language, which he or she performs in front of, and which is advantageously captured by, scanner (i.e., video camera) 112, which is connected (as an input device) to PC 106 (i.e., operator 107's PC). PC 106 then executes a program which performs sign language recognition on the received signs. This sign language recognition procedure is advantageously based on the results of a previously executed training (i.e., learning) algorithm, whereby the signs in the given language (e.g., ASL) have been previously “learned” by the system (see the detailed discussion below). PC 106 then advantageously converts the recognized signs to sign ID numbers which may be (easily) sent across low bandwidth channel 104 via network 105 (which may, for example, comprise the Internet) to PC 103, which is used by hearing impaired individual 101.

Then, upon receipt of this sequence of sign ID numbers by PC 103, the aforementioned signing display program is executed on the PC, by converting the sequence of sign ID numbers to a corresponding sequence of signs, which are advantageously displayed on PC monitor 114 as a sequence of images and/or video segments comprising a pair of “cartoon” hands (or other artificially created images and/or video segments having, at least, a pair of hands) which is drawn on the screen so as to display the corresponding sequence of received signs. Thus, hearing impaired individual 101 can view the displayed image sequence, which advantageously comprises a sign language translation of audio user 111's spoken voice.

In accordance with one illustrative embodiment of the present invention, the logic for the sign language recognition programs executed on the PCs of the operator and the hearing impaired user may be advantageously based on a conventional type of training (i.e., learning) algorithm that will be familiar to those of ordinary skill in the field of Artificial Intelligence in general, and in the field of Automatic Speech Recognition (ASR) techniques in particular. Specifically, a training process is advantageously employed during which known (i.e., previously identified) signs are captured by the video scanner and analyzed by the training software. In particular, during this training period, the program is rewarded numerically for correct mappings (identifications of a sign) and is punished numerically for incorrect mappings (identifications of a sign). After a suitable training period, the error rate of the sign recognition software can be advantageously reduced to an acceptable level. As previously pointed out, training algorithms such as these are conventional in the field of Artificial Intelligence in general, and in the field of Automatic Speech Recognition techniques in particular, and therefore, the adaptation of such algorithms to sign language recognition as described herein will be easily achievable by those skilled in the art.

In accordance with various illustrative embodiments of the present invention, training may be performed on either a signer-dependent or a signer-independent basis, or both. For example, the recognition software may be advantageously trained in a signer-dependent fashion by one or more specific individual signers (i.e., operators or hearing impaired individuals), with the results of each such training process then being specifically and advantageously associated with the given individual signer. Thus, when that particular individual signer (i.e., operator or hearing impaired individual) is using the system, the recognition software will be advantageously adapted to that specific individual by using a correspondingly trained sign recognition database.

Alternatively, or in addition thereto, the recognition software may be advantageously trained in a signer-independent fashion by a plurality of individual signers (i.e., operators and/or hearing impaired individuals). In this manner, a “new” signer (i.e., operator or hearing impaired individual) who had not previously been involved in the training of the recognition software may advantageously use the system based on such a signer-independently trained sign recognition database. Such techniques will be fully familiar to those skilled in the art of Automatic Speech Recognition (ASR) techniques, where the exact same training principles are applied in essentially the same manner to both speaker-dependent training and speaker-independent training techniques for ASR.

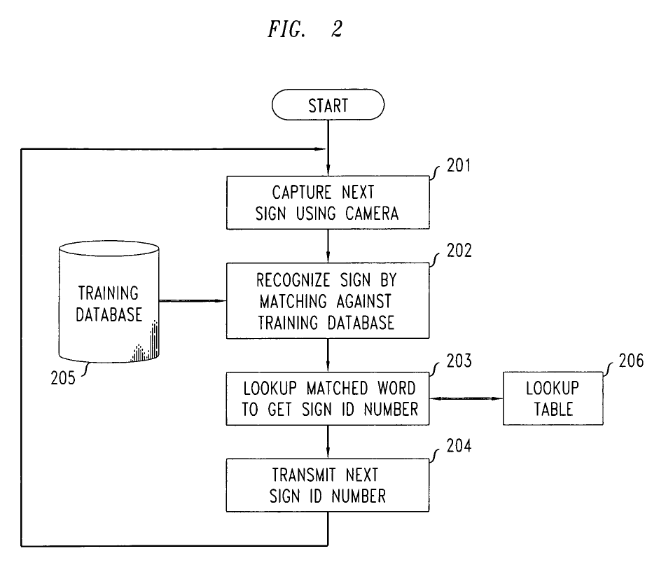

FIG. 2 shows a flowchart of a method for capturing and transmitting signs for use in performing a Video Relay Service call between a hearing impaired user and an audio user in accordance with one illustrative embodiment of the present invention. The method shown in the figure may, for example, be executed by PC 103 (i.e., hearing impaired individual 101's PC) of FIG. 1, using scanner 102, and/or may be executed by PC 106 (i.e., operator 107's PC) of FIG. 1, using scanner 112.

In particular, the illustrative method shown in FIG. 2 iteratively performs the following steps. First, in block 201, a video camera (i.e., a scanner) is used to capture the next sign (from the hearing impaired individual or from the operator, as the case may be). Then, using (previously trained) sign recognition database 205, the captured sign is recognized (in block 202) as being representative of one of the words for which one or more sign images are stored in the database. This recognition may, for example, be achieved by identifying the database entry having the best (i.e., closest) match to the captured sign. (Such matching of images will be fully familiar to those skilled in the art.)

Once the captured sign has been recognized as representative of a particular word, lookup table 206 is used (in block 203) to determine a corresponding sign ID number (i.e., an ID number which will be used to represent the identified word). Finally, in block 204, the sign ID number (which corresponds to the word represented by the captured sign) is transmitted (across a communications channel) for use by, for example, the operator's PC (if the illustrative method of FIG. 2 is being performed by the hearing impaired individual's PC) or the hearing impaired individual's PC (if the illustrative method of FIG. 2 is being performed by the operator's PC). The illustrative process then repeats by returning to block 201 to capture the next sign.

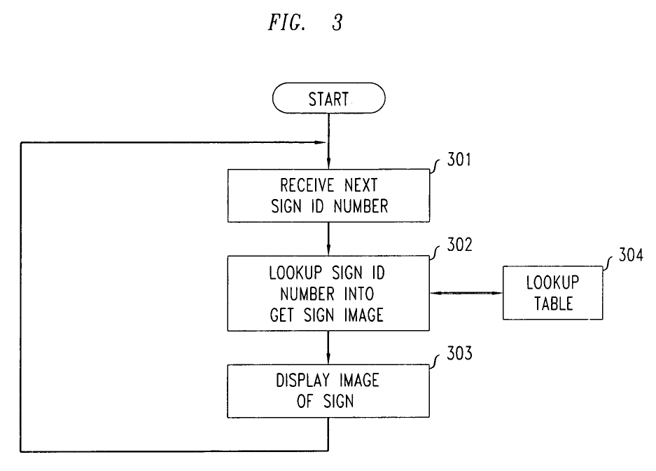

FIG. 3 shows a flowchart of a method for receiving and displaying signs for use in performing a Video Relay Service call between a hearing impaired user and an audio user in accordance with one illustrative embodiment of the present invention. The method shown in the figure may, for example, be executed by PC 103 (i.e., hearing impaired individual 101's PC) of FIG. 1, and/or may be executed by PC 106 (i.e., operator 107's PC) of FIG. 1.

In particular, the illustrative method shown in FIG. 3 iteratively performs the following steps. First, in block 301, the next sign ID number is received (from the communications channel). Then, lookup table 304 is used (in block 302) to identify the word corresponding to the received sign ID number, and to retrieve the corresponding sign image (or video segment) therefor. Finally, in block 303, the retrieved sign image (or video segment), which corresponds to the received sign ID number, is displayed on the monitor for use by the hearing impaired individual (if the illustrative method of FIG. 3 is being performed by the hearing impaired individual's PC), or by the operator (if the illustrative method of FIG. 3 is being performed by the operator's PC). The illustrative process then repeats by returning to block 301 to receive the next sign ID number from the communications channel.

Note that for many sign languages, such as, for example, ASL, the general “vocabulary” (i.e., the number of distinct signs) is less than about a thousand “words.” Therefore, the above-referenced training process, as well as the sizes of the sign recognition database and of the above-referenced lookup tables, will advantageously be quite manageable. In accordance with various illustrative embodiments of the present invention, a system may be advantageously trained with both such a general vocabulary as well as one or more specific vocabularies for one or more given businesses or industries.

Note also that many words in certain sign languages (such as, for example, ASL) are compound words which are created by stringing a number of signs together. In accordance with one illustrative embodiment of the present invention, for these compound words, the above described methods could advantageously recognize each individual hand position and then link the subsequence of signs (which make up such a compound word) together in order to create a single numeric sign ID number to represent the (compound) word. Then, when the sign ID number is received at the other end of the communications channel, the display process will display the corresponding subsequence of signs which make up the compound word identified by the received sign ID number, which the operator or the hearing impaired individual will appropriately understand.

In accordance with an another illustrative embodiment of the present invention, however, a numeric sign ID value may be assigned for each individual hand position (which makes up a compound word), and the resulting subsequence of sign ID numbers may then be transmitted to the other end of the communications channel. In this case, the display process will (naturally) display the subsequence of the individual hand positions, which the operator or the hearing impaired individual will appropriately understand. Either approach (or a combination of both) provides a system which operates with much lower bandwidth requirements as compared to prior art systems which transmit a video signal.

Note that, in accordance with certain illustrative embodiments of the present invention, a hearing impaired individual can advantageously select the particular sign language or dialect (e.g., ASL) to be used while setting up a user account with default characteristics. Illustratively, the hearing impaired individual could, of course, specify a different sign language (or dialect) to be used for any given call.

Note also that, in accordance with various illustrative embodiments of the present invention, the above-described scanning of the human signer (e.g., the operator and/or the hearing impaired individual) may be advantageously accomplished by any of a number of technologies which will be fully familiar to those of ordinary skill in the art. These technologies include, for example, the optical (video) scanning technique discussed above (and shown. for example, in the illustrative embodiment of FIG. 1), as well as physiological techniques in which the signer has, for example, various sensors attached to his or her fingers, arms, and/or the body thereof. In either case, the signs may be advantageously recognized with use of conventional techniques which will be obvious to those skilled in the art, and the recognized signs may then be advantageously converted into sign ID numbers and transmitted as such, in accordance with the illustrative embodiments of the present invention as otherwise described above.

Finally, in accordance with other illustrative embodiments of the present invention, both of the parties to a conversation may communicate (either partially or completely) via sign language. In such a case, both parties to the conversation may advantageously have scanners (attached to PCs) for capturing their respective signing, as well as monitors for providing respective “cartoon” hand displays (or other artificially created images or video segments having at least a pair of hands) representing the other party's signing. In this manner, two hearing impaired individuals may advantageously communicate with each other over a low bandwidth communications channel. Note that in such a case, the operator may or may not be used to provide an intermediate relay point for the conversation, since the functions of the operator are no longer required.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for providing a telecommunications service for use by a hearing impaired individual, the method comprising the steps of:
capturing a sequence of signs produced by a signing person in accordance with a predetermined sign language;
identifying each of said signs in said sequence of signs produced by the signing person as corresponding to a particular sign in said predetermined sign language, thereby generating a sequence of identified signs in said predetermined sign language;
determining a sequence of numerical indicia representative of said sequence of identified signs in said predetermined sign language, each of said numerical indicia corresponding to one or more of said signs in said sequence of identified signs; and
transmitting the sequence of numerical indicia across a communications channel for use in said telecommunications service.

2. The method of claim 1 wherein the signing person comprises the hearing impaired individual.

3. The method of claim 1 wherein the signing person comprises an operator in a Video Relay Service assisted call.

4. The method of claim 1 wherein the step of capturing the sequence of signs produced by the signing person is performed with use of a video camera.

5. The method of claim 1 wherein the step of identifying each of said signs in said sequence of signs produced by the signing person is performed by comparing each of said signs produced by the signing person as captured with a plurality of entries in a sign recognition database in order to locate a best match thereto, wherein the sign recognition database was previously created with use of a training technique, wherein the training technique comprised one or more signing persons providing known signs thereto.

6. The method of claim 1 wherein said numerical indicia comprise sign ID numbers, each sign ID number corresponding to one or more of said signs in said sequence of identified signs.

7. The method of claim 1 further comprising the steps of:
receiving the transmitted sequence of numerical indicia from the communications channel;
selecting, for each of said received numerical indicia in said sequence, one or more corresponding images and/or video segments for display, wherein each of said images and/or video segments comprises an illustration of at least a pair of hands, and wherein each of said images and/or video segments shows a particular one of said signs in said predetermined sign language being produced by said pair of hands, said particular one of said signs in said predetermined sign language corresponding to said received numerical indicia representative thereof; and
displaying each of said selected images and/or video segments in sequence, thereby generating a display of a sequence of images and/or video signals corresponding to the received sequence of numerical indicia.

8. A method for providing a telecommunications service for use by a hearing impaired individual, the method comprising the steps of:
receiving a sequence of numerical indicia from a communications channel, the sequence of numerical indicia being representative of a sequence of signs in a predetermined sign language;
selecting, for each of said received numerical indicia in said sequence, one or more corresponding images and/or video segments for display, wherein each of said images and/or video segments comprises an illustration of at least a pair of hands, and wherein each of said images and/or video segments shows a particular one of said signs in said predetermined sign language being produced by said pair of hands, said particular one of said signs in said predetermined sign language corresponding to said received numerical indicia representative thereof; and
displaying each of said selected images and/or video segments in sequence, thereby generating a display of a sequence of images and/or video signals corresponding to the received sequence of numerical indicia.

9. The method of claim 8 wherein said numerical indicia comprise sign ID numbers, each sign ID number corresponding to one or more signs in a predetermined sign language.

10. The method of claim 8 wherein said illustrations comprise cartoon drawings of said particular ones of said signs in said predetermined sign language being produced by said pair of hands.

11. An apparatus for providing a telecommunications service for use by a hearing impaired individual, the apparatus comprising:
a scanner, which captures a sequence of signs produced by a signing person in accordance with a predetermined sign language;
a processor, which
(a) identifies each of said signs in said sequence of signs produced by the signing person as corresponding to a particular sign in said predetermined sign language, thereby generating a sequence of identified signs in said predetermined sign language, and
(b) determines a sequence of numerical indicia representative of said sequence of identified signs in said predetermined sign language, each of said numerical indicia corresponding to one or more of said signs in said sequence of identified signs; and
a transmitter, which transmits the sequence of numerical indicia across a communications channel for use in said telecommunications service.

12. The apparatus of claim 11 wherein the signing person comprises the hearing impaired individual.

13. The apparatus of claim 11 wherein the signing person comprises an operator in a Video Relay Service assisted call.

14. The apparatus of claim 11 wherein the scanner comprises a video camera.

15. The apparatus of claim 11 further comprising a sign recognition database, wherein the processor identifies each of said signs in said sequence of signs produced by the signing person by comparing each of said signs produced by the signing person as captured by said scanner with a plurality of entries in the sign recognition database in order to locate a best match thereto, wherein the sign recognition database was previously created with use of a training technique, wherein the training technique comprised one or more signing persons providing known signs thereto.

16. The apparatus of claim 11 wherein said numerical indicia comprise sign ID numbers, each sign ID number corresponding to one or more of said signs in said sequence of identified signs.

17. The apparatus of claim 1 further comprising:
the communications channel;
a receiver, which receives the transmitted sequence of numerical indicia from the communications channel;
a second processor, which selects, for each of said received numerical indicia in said sequence, one or more corresponding images and/or video segments for display, wherein each of said images and/or video segments comprises an illustration of at least a pair of hands, and wherein each of said images and/or video segments shows a particular one of said signs in said predetermined sign language being produced by said pair of hands, said particular one of said signs in said predetermined sign language corresponding to said received numerical indicia representative thereof; and
a display, which displays each of said selected images and/or video segments in sequence, thereby generating a display of a sequence of images and/or video signals corresponding to the received sequence of numerical indicia.

18. An apparatus for providing a telecommunications service for use by a hearing impaired individual, the apparatus comprising:
a receiver, which receives a sequence of numerical indicia from a communications channel, the sequence of numerical indicia being representative of a sequence of signs in a predetermined sign language;
a processor, which selects, for each of said received numerical indicia in said sequence, one or more corresponding images and/or video segments for display, wherein each of said images and/or video segments comprises an illustration of at least a pair of hands, and wherein each of said images and/or video segments shows a particular one of said signs in said predetermined sign language being produced by said pair of hands, said particular one of said signs in said predetermined sign language corresponding to said received numerical indicia representative thereof; and
a display, which displays each of said selected images and/or video segments in sequence, thereby generating a display of a sequence of images and/or video signals corresponding to the received sequence of numerical indicia.

19. The apparatus of claim 18 wherein said numerical indicia comprise sign ID numbers, each sign ID number corresponding to one or more signs in a predetermined sign language.

20. The apparatus of claim 18 wherein said illustrations comprise cartoon drawings of said particular ones of said signs in said predetermined sign language being produced by said pair of hands.
